(19) United States
(12) Patent Application Publication
(10) Pub. No.: US 2011/0044126 A1
(43) Pub. Date: Feb. 24, 2011

(54) MEDIA MIXING APPARATUS

(76) Inventor: Charles E. Hull, Newtown, CT (US)

Correspondence Address: SOFER & HAROUN LLP., 317 MADISON AVENUE, SUITE 910, NEW YORK, NY, 10017, US

(21) Appl. No.: 12/620,723

(22) Filed: Nov. 18, 2009

Related U.S. Application Data
(60) Provisional application No. 61/236,326, filed on Aug. 24, 2009.

(51) Int. Cl. B01F 7/00; B01F 15/02

(52) U.S. Cl. 366/153.3

(57) ABSTRACT

A media mixing apparatus for mixing rock salt and a media having a housing with a rotatable auger mounted longitudinally within the housing. The housing has a first lower end, an intermediate section and a second end raised relative to the first end. A hopper is coupled to the first end of the housing so that the rotatable auger extends into the hopper for moving the soil toward the second raised end. A valve apparatus is coupled to the housing at the intermediate section for introducing the media to the rock salt as the rock salt is moved from the hopper to the second raised end.

### BACKGROUND OF THE INVENTION

Mixing solids and liquids is well documented in the art. Mixers are often used to mix solids with other solids and liquids. Solids generally refer to particles ranging in size from 1 micron to 2 centimeters. Liquids generally refer to incompressible materials having no shear modulus.

Mixers in the art introduce solids and liquids through a series of stages in an apparatus, such as one stage at either an intermediate or end position. Solids in bulk raw material form are typically introduced to a hopper at the first stage of an apparatus. The hopper may have agitation to assist with transferring the solids from the hopper. The solids, after passing through the hopper, are transferred through different stages of the apparatus using one or more augers.

An auger is an axially rotatable screw feed. In the art, an auger is commonly used to feed solids into a mixer. The mixer may have an axially rotatable impellor for dispersing the solids throughout the liquids. The mixing process is often centrifugal, which creates a vacuum inside of the mixing device. The resulting mixture of solids and liquids is then drained or pumped from the mixer and used as either the end product or the material for the next step in the process.

The proper mixing of the solids into the liquids may depend upon differences in the amount of the solid present, its particle size, viscosity, or temperature. Proper dispersion also depends upon back pressure at the mixer outlet. In addition, the mixer itself may impede the mixing process. The mixer's centripetal force can create a vacuum that draws in solids at an uncontrollable rate, causing them to mix with the liquids at a variable supply rate.

Pnuematic conveying systems utilizing auger conveyor sections are also used in the art to transport various particulate materials, including pulverized coal, portland cement, grain, and pulverized ore. Typically, the conveying systems contain a motor driven auger rotatably mounted within a barrel, and a mixing chamber where the material is subjected to one or more jets of pressurized air or other gas.

Mixers joined in tandem are also known in the art, and frequently contain a dwell chamber between two mixing heads. Some mixing systems in the art are chemical reforming systems in which organic materials such as municipal waste or coal are chemically reformed from solid materials by pyrolysis in the presence of water to form oils and gasses.

Another area in which the process of mixing solids and liquids is utilized is in preparing soil or other media to be used for potted plants or gardening. Preparing soil mixtures containing fertilizer and/or insecticide that can be used to grow potted plants or placed in gardens involves a number of steps. Generally, bale or bulk media, such as soil, is broken up and then treated with fertilizer and/or insecticide. This treatment process frequently exposes operators to the various chemicals being used.

In addition, commercial mixing apparatuses such as those discussed above, and examples of which are cited below, utilize heavy machines that are not easily moved from one location to another. Many of the devices in the art are specifically designed for chemical systems that do not handle heavier materials, such as soil. In addition, mixing soil with various fertilizers or chemicals is a delicate process often requiring a gentle action so as to not crush the vermiculite, which are minerals found in the soil that help plants absorb potassium.

One example of a prior art apparatus is found in U.S. Pat. No. 6,712,496 B2, issued Mar. 30, 2004 to Louis Alvin Kressin, et al. The Kressin et al. apparatus utilizes an auger to transport solids from a hopper to a mixer with a controlled delivery rate of the solids into the mixer without the need for an evacuation step. The apparatus receives solids at a hopper inlet and distributes them through a hopper outlet into a throat section containing an axially rotatable auger. The throat section has an outlet in communication with a mixer. The axial rotation of the auger moves the solids through the throat section and into the mixer. The delivery rate of the soil into the mixer is in proportion with the rotational speed of the auger. This reference deals primarily with achieving sufficient distribution of solids in a liquid.

Another example of a prior art apparatus is found in U.S. Pat. No. 5,500,120, issued Mar. 19, 1996 to David L. Baker. The Baker apparatus chemically reforms organic materials using a rotational tube positioned in a tubular housing, and a flow conduit system that allows fluid material within the housing to move between different access ports within the housing. The device allows various raw materials to be chemically reformed.

A third example of a prior art apparatus is found in U.S. Pat. No. 4,438,072, issued Mar. 20, 1984 to Joseph L. Nothnagel. The Nothnagel apparatus discloses a mixing device containing a reverse-twist auger located within a dwell chamber. The device incorporates a number of valves and conduits to supply reactants to liquid within the dwell chamber, allowing for component mixing and dwell time. The device also contains a dispensing valve and includes a means for cleaning the valve to prevent reactant buildup. The products, after leaving the dwell chamber, travel to a second mixing head and then a final valve, which releases the final product. This device focuses on allowing increased dwell time of mixtures without permitting a buildup of reactive material on the walls of the dwell chamber, and relates to polyurethane gels filled with particles of aqueous solutions.

A fourth example of a prior art apparatus is found in U.S. Pat. No. 4,711,607, issued on Dec. 8, 1987 to Charles Wynosky. The Wynosky apparatus discloses a conveying system that utilizes a hopper-fed auger section for transporting material through and toward the end of a barrel, and mixing said material with a pressurized gas flow. The auger conveyor section includes a cylindrical barrel enclosing a rotatably mounted auger conveyor for transporting particulate material towards a discharge end of the barrel and for ejecting the material. The invention inserts pressurized gas to help propel material through the conduit.

A fifth example of a prior art apparatus is found in U.S. Pat. No. 5,005,980, issued on Apr. 9, 1991 to Harold Zimmerman. The Zimmerman apparatus discloses a mixing machine that processes waste materials for disposal by mixing the waste with an inert material, such as soil. The apparatus receives waste and inert materials in separate hoppers and conveys them to a mixing chamber for uniform mixing in prescribed ratios. Each hopper contains augers that pull material away from the hopper to the mixing chamber, which also contains an auger. The material is discharged from the machine after passing through the mixing chamber. The apparatus is designed to be mounted on a trailer or permanently mounted on the ground. Each component of this machine is hydraulically driven to provide for independent operation.

A sixth example of a prior art apparatus is found in U.S. Pat. No. 7,069,677 B2, issued on Jul. 4, 2006 to Cheng-Feng Chang. The Chang apparatus discloses a method for producing a ready-mix soil material by crushing earth material from a work site, sieving the earth material to obtain raw soil, and mixing metered'amounts of the soil with at least one strength enhancing additive. The resulting mixture is then used to refill a work site. The method also involves establishing a database for soil mix combinations and corresponding mechanical properties. This reference focuses on reducing discarded earth material at work sites by using the material to create refilling material.

### BRIEF SUMMARY OF THE INVENTION

One embodiment of the invention comprises a soil mixing apparatus for mixing soil and a media. The apparatus utilizes a housing having a rotatable auger mounted longitudinally within the housing. The housing is provided with a first lower end, an intermediate section and a second end, the second end raised relative to said first end. A hopper is coupled to a first end of said housing so that the rotatable auger extends into the hopper for moving the soil toward the second raised end. A valve apparatus is coupled to the housing at the intermediate section of the housing for introducing the media to the soil as the soil is moved from the hopper to the second raised end. The rotatable auger is provided with a series of spaced flites so that the soil can be moved from the end through the intermediate section and to the second raised end. An inlet water supply allows water to be introduced at the intermediate section. A treatment inlet supply allows an additive to be added to the soil at the intermediate section.

An object of this invention is to transport soil and other potting to an elevated discharge location after it is treated with chemicals or fertilizer, thereby reducing operator exposure to insecticides and fertilizers.

These and other objects are achieved by a soil mixing apparatus that includes a housing having a rotatable auger mounted longitudinally within it, said housing having a first lower end, an intermediate section, and a second end. The'housing is attached to a hopper at the first end, a valve apparatus at the intermediate section, and a motor at the second end. The motor rotates the rotatable auger, which transports the soil from the ground through the intermediate section of the housing and toward said second end. In the intermediate section of the housing, a valve apparatus supplies water, various fertilizers, and/or insecticides to the soil. When the soil reaches said second end of said housing, it is discharged and deposited onto a flat filler, bench top, or other elevated location.

The height and angle of the soil mixing apparatus are adjustable via a wheel assembly.

### BRIEF DESCRIPTION OF THE DRAWINGS

FIG. 1 is a side perspective view of the media mixing apparatus, embodying various features of the present invention;

FIG. 2 is an opposite side view of the valve apparatus of the media mixing apparatus of FIG. 1;

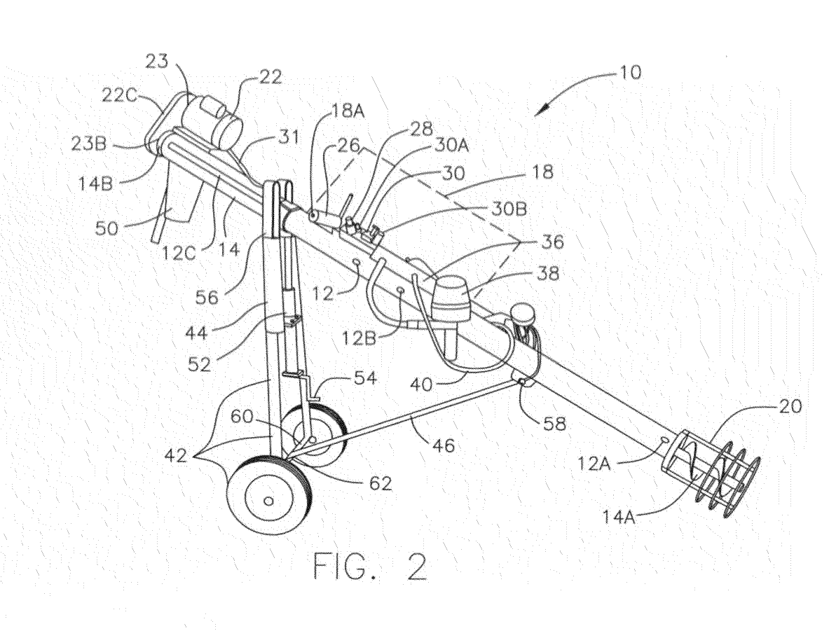

FIG. 3 is a an additional side perspective view of the media mixing apparatus in a raised position;

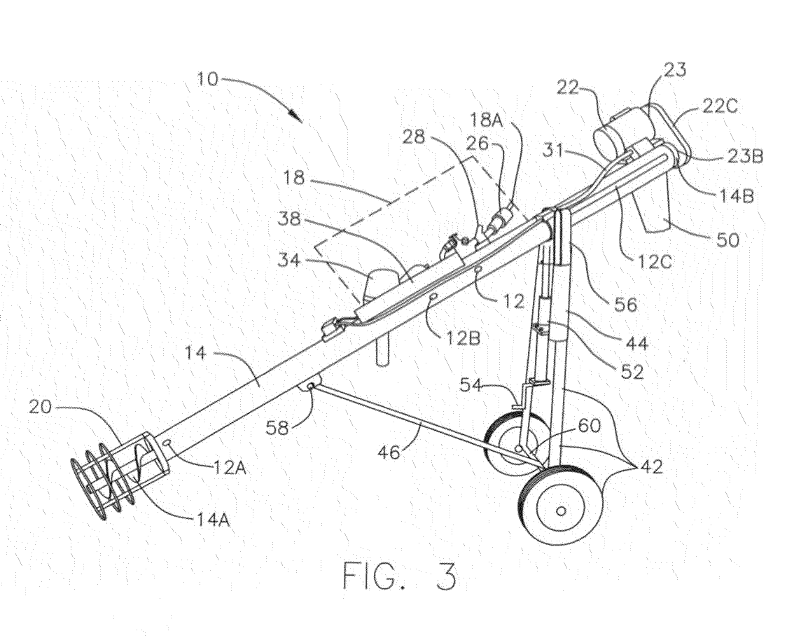

FIG. 4 is an additional side perspective view of the media mixing apparatus of FIG. 1 showing the media mixing apparatus in a lowered position; and

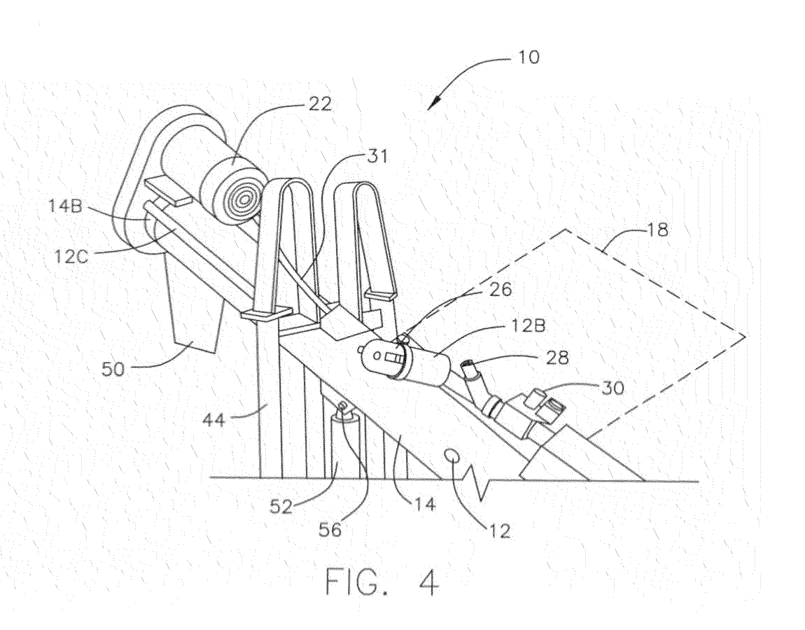

FIG. 5 is a front top perspective view of the housing, the hopper, and the first free end of the rotatable auger of the media mixing apparatus of FIG. 1.

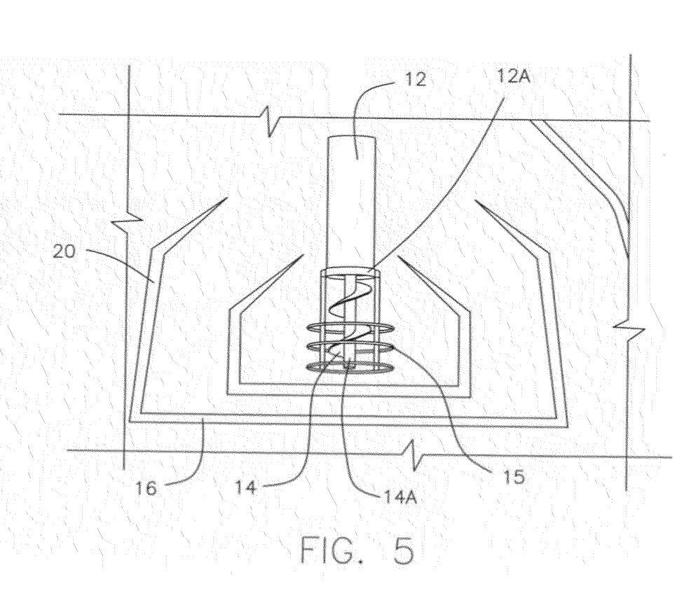

### DETAILED DESCRIPTION OF THE INVENTION

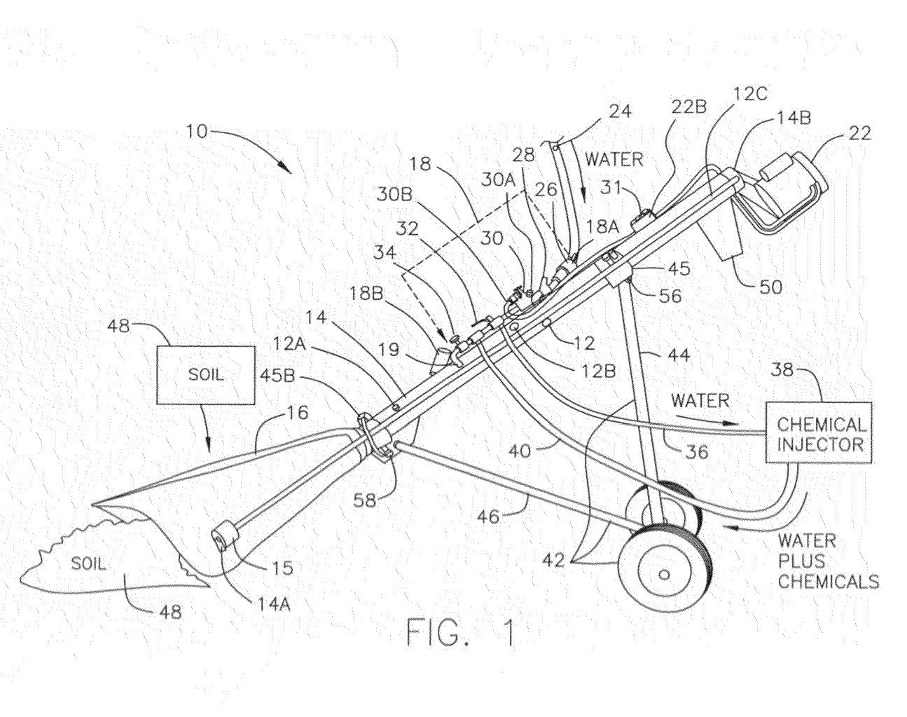

The soil mixing apparatus of the present invention is shown in FIG. 1 and indicated generally by reference character 10. FIG. 1 shows a front view of soil mixing apparatus 10. It contains a housing 12 having a first end 12a, an intermediate section 12b, and a second end 12c. A rotatable auger 14 having a first free end 14a and a second end 14b is mounted longitudinally within housing 12, and extends into a hopper 16, which is attached to housing 12 at first end 12a. A guard 15 attaches to first end 12a of housing 12 and surrounds first free end 14a of rotatable auger 14. A valve apparatus 18 having a first end 18a and a second end 18b attaches to intermediate section 12b of housing 12. Housing 12 contains a notch 19 on intermediate section 12b where second end 18b of valve apparatus 18 attaches to intermediate section 12b of housing 12. Rotatable auger 14 contains a number of spaced flites 20, and is connected to a motor 22 at first end 14a. Motor 22 is mounted at second end 12c of housing 12.

Valve apparatus 18 is connected to an inlet water supply 24 at first end 18a of valve apparatus 18. Valve apparatus 18 contains, starting at first end 18a and moving in series toward second end 18b, a water filter 26, a pressure regulator 28, a regulator valve 30 having a first side 30a and a second side 30b, a control valve 32, and a gate valve 34. A regulating circuit 31 connects motor 22 to regulator valve 30. A treatment outlet supply 36 is mounted to valve apparatus 18 at second side 30b of regulator valve 30. Treatment outlet supply 36 connects to a chemical injector 38. A treatment inlet supply 40 is mounted to valve apparatus 18 between control valve 32 and gate valve 34. Treatment inlet supply 40 connects to chemical injector 38.

Soil mixing apparatus 10 is supported by a wheel assembly 42 having a first arm 44 and a second arm 46 connecting to intermediate section 12b and first lower end 12a respectively.

In one embodiment of the present invention, the following are an exemplary list of dimensions for construction:

Housing 12 is 10′ long, hollow cylinder with ⅛″ thick steel.

Rotatable auger 14 is approximately 11′ long.

Flites 20 are 1.625″ wide and spaced approximately 4″ apart.

Guard 15 is ¼″ thick with a 1″ band iron strap, 9″ long by 9″ wide, and has an open top.

Notch 19 is 2″ wide and 1″ deep, and located on intermediate section 12b of housing, approximately 4′8″ from first end 12a of housing 12.

Hopper 16 is 23″ deep by 47″ in the top rear and tapers to 12″ in the bottom rear. The front of hopper 16 tapers, conforms to housing 12, and is held to housing 12 with a number of nylon straps and buckles 21.

Regulating circuit 31 is wired with 110 Volts and a minimum of 15 Amps grounded plug with 18″ of #12 wire connected to a switch 22b and to regulator valve 30. Wiring is routed from regulator valve 30 to switch 22b to motor 22. When switch 22b is in the ‘on’ position, motor 22 and regulator valve 30 operate at the same time to allow water from inlet water supply 24 to flow through valve apparatus 18 as rotational auger 14 turns.

Wheel assembly 42 has a number of tires 42a that are pneumatic 4.80×4.00×8(2) and an axle 42b that is ½″ diameter and 39″ long with locking collars 42c at the end of axle 42b. First arm 44 and second arm 46 of wheel assembly 42 attach to housing 12 by an adjustable clamp 45 that fits around housing 12. Rubber straps are placed underneath clamp 45 to prevent clamp 45 from slipping along housing 12.

Motor 22 is 1 horsepower with 1728 RPM rotation. Motor 22 has a pulley with a ½″ belt that drives rotational auger 14.

Inlet water supply 24 uses standard garden hose at ¾″ piping.

Water filter 24 is 10 Micron Netafin.

Pressure Regulator 28 is 35 PSI.

Regulator valve 30 is 110 Volts and wired in conjunction with motor 22 to operate at the same time.

Please note that the above listed example dimensions and specifications are not intended to limit the invention. Any similar dimensions that meet the above requirements are also within the scope of this invention.

Motor 22 rotates rotatable auger 14 at second end 14b in a clockwise direction looking towards first lower end 12a of housing 12. Flites 20 on rotatable auger 14 also turn in a clockwise direction, which drives first free end 14a of rotatable auger 14 into soil 48. Flites 20 and auger 14 break up and displace clumps of soil 48, driving soil 48, guided by hopper 16, into first lower end 12a of housing 12, through intermediate section 12b of housing 12, and toward second end 12c of housing 12. An operator can facilitate the movement of soil 48 by pushing soil 48 into hopper 16 or by pushing first arm 44 of wheel assembly 42 of soil mixing apparatus 10 such that hopper 16 is pushed into soil 48, thus driving soil mixing apparatus 10 forward and driving hopper 16 and first free end 14a of rotatable auger 14 into soil 48.

As soil 48, driven along the interior of housing 12 by rotatable auger 14 and flutes 20, reaches notch 19 in housing 12, water and/or chemicals are introduced to soil 48. Inlet water supply 24 supplies water to valve apparatus 18. Water from inlet water supply 24 passes through water filter 26, pressure regulator 28, and regulator valve 30. {{Regulator valve 30 is controlled by regulating circuit 31, which connects motor 22 and regulator valve 30 such that the volumetric flow of inlet water supply 24 correlates with the speed of motor 22.}}

If control valve 32 is in the open position, then water from inlet water supply 24 flows through control valve 32 and gate valve 34, and mixes with soil 48 inside housing 12 at second end 18b of valve apparatus 18 where notch 19 is located in housing 12. If control valve 32 is in the closed position, then water from inlet water supply 24 flows into treatment outlet supply 36 toward chemical injector 38, is treated with fertilizers or insecticides in chemical injector 38, and driven back towards valve apparatus 18 through treatment inlet supply 40, connecting back to valve apparatus 18 between control valve 32 and gate valve 34. The treated water from treatment inlet supply 40 then flows through gate valve 34 and mixes with soil 48 inside housing 12 at second end 18b. Wet soil 48 mixed with water and/or chemicals continues up housing 12 toward second end 12c of housing 12.

When soil 48 mixed with water and/or chemicals reaches second end 12c of housing 12, it falls through discharge chute 50 and onto a flat filler, bench top, or other elevated location.

The soil mixing apparatus 10 is supported by wheel assembly 42. The height of the soil mixing apparatus 10 can be adjusted by adjusting adjustable clamps 45 and moving first arm 44 and second arm 46 of wheel assembly 42.

A further embodiment of the present invention comprises a media mixing apparatus utilizing a housing having a rotatable auger mounted longitudinally within the housing. The housing is provided with a first lower end, an intermediate section and a second end, the second end raised relative to said first end. A hopper is coupled to a first end of said housing so that the rotatable auger extends into the hopper. A valve apparatus is coupled to the housing at the intermediate section of the housing for introducing the media. An inlet water supply allows water to be introduced at the intermediate section. A treatment inlet supply allows an additive to be added to the media at the intermediate section.

One object of the present invention is to utilize the media mixing apparatus to mix rock salt with either Calcium Chloride, Potassium, or Magnesium and then apply it to ice in order to melt the ice.

Sodium Chloride, also known as rock salt sold by Morton's® of Chicago, Ill., United Salt Company® of Houston, Tex., and Diamond Crystal® of Michigan, is known to melt ice up until 18° F. For temperature lower than 18° F., either Calcium Chloride, Potassium or Magnesium must be added to the rock salt. Calcium Chloride, Potassium and Magnesium can be purchased in 50 lb bags from fertilizer companies, such as Lesco of Ohio or Agway of Westfield Mass.

According to one embodiment of the invention, per ton between 5-7 gallons of 100% solution of either Calcium Chloride, Potassium or Magnesium is added to the rock salt. Any measurement of media lower than 5 gallons is too watery and any measurement above 7 gallons is too concentrated for optimal results. The solution is sprayed onto the rock salt in the intermediate section of the media mixing apparatus. This mixture of rock salt and media melts ice up until −35° F., a 50° temperature difference from the rock salt alone.

In a further embodiment of the present invention, a marking dye is added to indicate whether the salt was uniformly mixed with the additive media.

1. A media mixing apparatus for mixing rock salt and a media, said apparatus comprising:
a housing having a rotatable auger mounted longitudinally within said housing, said housing having a first lower end, an intermediate section and a second end raised relative to said first end;
a hopper coupled to said first end of said housing so that said rotatable auger extends into said hopper for moving the soil toward said second raised end; and
a valve apparatus coupled to said housing at said intermediate section of said housing for introducing the media to the rock salt as the rock salt is moved from said hopper to said second raised end.

2. The media mixing apparatus of claim 1, wherein said rotatable auger is provided with a series of spaced flites so that the rock salt is moved from said first lower end, through said intermediate section and to said second raised end.

3. The apparatus of claim 1, further comprising a motor coupled to said rotatable auger for rotating said rotatable auger.

4. The apparatus of claim 1 wherein said valve apparatus comprises an inlet water supply, such that water may be introduced at said intermediate section to the rock salt.

5. The apparatus of claim 4, further comprising a treatment outlet supply and a treatment inlet supply for providing a treatment, said treatment outlet supply

6. The apparatus of claim 5, wherein the treatment is an insecticide.

7. The apparatus of claim 5, wherein the treatment is a fertilizer.

8. The apparatus of claim 5, further comprising a control valve mounted between said treatment outlet supply and said treatment inlet supply for controlling the amount of treatment introduced into said housing.

9. The apparatus of claim 1, wherein said second raised end is provided with a discharge chute for discharging said treated rock salt.

10. The apparatus of claim 1, further comprising a wheel assembly connected to said housing, so that said media mixing apparatus is movable.

11. The apparatus of claim 1, wherein said housing is inclined at an angle of approximately 25-45 degrees relative to the ground.

12. The apparatus of claim 11, wherein the height of said housing is adjustable so that said angle of incline may be varied between 25-45 degrees.

13. The apparatus of claim 3, further comprising a regulator valve for regulating said inlet water supply, and a regulating circuit connecting said motor with said regulator valve such that the volumetric flow of said inlet water supply is directly correlated with the speed of said motor, said auger, and said rock salt.

14. The apparatus of claim 1, wherein said housing is an enclosed cylinder.

15. A mixing apparatus for mixing rock salt, water and a fertilizer, said apparatus comprising:
a housing having a rotatable auger mounted longitudinally within said housing, said housing having a first lower end, an intermediate section and a second end raised relative to said first end;
a hopper coupled to said first end of said housing so that said auger extends into said hopper for moving rock salt toward said second raised end; and
a valve apparatus coupled to said housing at said intermediate section of said housing for introducing water to said rock salt as said rock salt is moved from said hopper to said second raised end, said valve apparatus further comprising a fertilizer outlet supply and a fertilizer inlet supply for mixing fertilizer with said water, such that said fertilizer and said water may be introduced to said rock salt at said intermediate section of said housing.

16. The media mixing apparatus of claim 15, wherein said rotatable auger is provided with a series of spaced flites so that the rock salt is moved from said first lower end, through said intermediate section, and to said second raised end.

17. The apparatus of claim 15, further comprising a motor coupled to said rotatable auger for rotating said rotatable auger.

18. The apparatus of claim 15, wherein said valve apparatus further comprises an insecticide outlet supply and an insecticide inlet supply for mixing insecticide with said water such that said insecticide and said water may be introduced to said rock salt at said intermediate section of said housing.

19. The apparatus of claim 15, further comprising a control valve mounted between said fertilizer outlet supply and said fertilizer inlet supply for controlling the amount of fertilizer introduced into said housing.

20. The apparatus of claim 15, wherein said second raised end is provided with a discharge chute for discharging said treated rock salt.
